(19) United States
(12) Patent Application Publication
(10) Pub. No.: US 2026/0355818 A1
(43) Pub. Date: Nov. 12, 2026

(54) COMPOSITE METALLIC POWDER MATERIAL AND HIGH DENSITY MANUFACTURED COMPONENTS

(71) Applicant: Siemens Energy Global GmbH & Co. KG, Munich, Bayern (DE)

(72) Inventors: Andreas Graichen, Norrkoping (SE); Faraz Deirmina, Heby (SE)

(73) Assignee: Siemens Energy Global GmbH & Co. KG, Munich, Bayern (DE)

(21) Appl. No.: 19/475,323

(22) PCT Filed: Mar. 25, 2024
(86) PCT No.: PCT/EP2024/057948

§ 371 Date: Oct. 14, 2025

(30) Foreign Application Priority Data
Apr. 28, 2023 (GB) 2306346.4

(51) Int. Cl. B22F 1/16; B22F 1/05; B22F 1/065; B22F 3/22; B22F 3/24; B22F 10/14; B22F 10/64; B33Y 10/00; B33Y 40/20

(52) U.S. Cl. CPC B22F 1/16; B22F 1/05; B22F 1/065; B22F 3/225; B22F 3/24; B22F 10/14; B22F 10/64; B33Y 10/00; B33Y 40/20; B22F 2003/248; B22F 2301/10; B22F 2302/40; B22F 2304/10; B22F 2998/10; B22F 2999/00

(57) ABSTRACT

An improved metallic powder material providing improved characteristics for binder jetting and metal injection molding. The metallic powder material has separate metal powder particles, each containing a core and a coating containing carbon nanoparticles and/or graphene, wherein the core is a copper based metallic particle, a Ni based superalloy metal particle and/or a Fe based alloy metal particle.

### CROSS REFERENCE TO RELATED APPLICATIONS

This application is the US National Stage of International Application No. PCT/EP2024/057948 filed 25 Mar. 2024, and claims the benefit thereof, which is incorporated by reference herein in its entirety. The International Application claims the benefit of United Kingdom Application No. GB 2306346.4 filed 28 Apr. 2023.

### FIELD OF INVENTION

The present invention refers to an improved metallic powder material providing improved characteristics for binder jetting and metal injection molding. Furthermore, the present invention refers to a method of manufacturing utilizing binder jetting or metal injection molding utilizing such metallic powder material. Additionally, the present invention refers to a green body or brown body manufactured by the inventive method utilizing the metallic powder material.

### BACKGROUND OF INVENTION

Recently manufacturing methods like binder jetting and metal injection molding being highly versatile methods became available. While they gained significant interest and already had significant impact also in the industrial area they are still subject to continuous improvements to increase their applications, broaden their fields of action and improve the products manufactured herewith.

Still such manufacturing methods like binder jetting and metal injection molding are to this point lower priority methods for many applications based on their limitations and restrictions. Also, effects like subsequent shrinking of manufactured green bodies during sintering and the like or the impaired characteristics of non-sintered green bodies require a high amount of expertise and provide surprises when utilizing such methods. Even minor not well understood effects may result in significant problems of correspondingly manufactured products and their subsequent application. Therefore, there is, for example, still a need to provide materials providing a higher reliability when utilized and simplifying the corresponding manufacturing processes. Allowing to utilize such methods in a more generic way to make best use of the flexibility available from binder jetting and metal injection molding in general without suffering from the very specific problems available to such manufacturing methods.

### SUMMARY OF INVENTION

These problems are solved by the methods and products as disclosed hereafter and in the claims. Further beneficial embodiments are disclosed in the dependent claims and the further description. These benefits can be used to adapt the corresponding solution to specific needs or to solve further problems.

### DETAILED DESCRIPTION OF INVENTION

According to one aspect the present invention refers to a metallic powder material consisting of separate metal powder particles, wherein the metal powder particles each contain a core and a coating containing carbon nanoparticles and/or graphene, preferably carbon nanoparticles or graphene, even more preferred carbon nanoparticles, wherein the core is a copper based metallic particle, a Ni based superalloy metal particle and/or a Fe based alloy metal particle, preferably wherein the core is a copper based metallic particle, a Ni based superalloy metal particle, or a Fe based alloy metal particle wherein the Ni based superalloy metal particle contains a total amount of Al and Ti being less than 1 wt. % and a total amount of V, Zr, Nb, Ta and Y of less than 0.5wt. %, based on the total weight of the Ni based superalloy, metallic particle, wherein the Fe based alloy metal particle contains a total amount of Al and Ti being less than 1 wt. %, a total amount of V, Zr, Nb, Hf and Y being less than 0.5wt. %, and preferably providing a delta ferrite structure being thermodynamically stable in the temperature ranges of 80% to 100% of solidus temperature, wherein the metal powder particles provide a D₉₀ of at most 53 μm, preferably at most 32 μm, more preferred at most 25 μm, more preferred at most 16 μm, wherein the average amount of carbon nanoparticles is selected from the range from 0.01wt.-% to 0.05wt.-%, based on the total weight of the metal powder particles. The inventors noted that corresponding metallic powder particles provide significant benefits for binder jetting and metal injection molding.

While it seems surprising it was noted that such very minor amount of fine carbon material like carbon nanoparticles and graphene provide significantly improved characteristics for manufacturing methods like especially binder jetting and metal injection molding. While it is expressively pointed out that the following is limiting the present invention it is assumed by the inventors that the simplified processing as well as improved results observed for such manufactured methods is based on influencing the surface characteristics as well as chemical and physical behavior of the corresponding surfaces of the metal powder particles. Starting from an improved flowability and spreadability of the metallic powder material and sintered density observed for correspondingly manufactured green bodies with prior curing and debinding process. As well as subsequent enhanced chemical purity in view of the reduction of oxides of correspondingly manufactured products. For example, an inventive amount of 0.02 wt.-% nanocarbon particles distributed on the surface of a copper powder additionally reliably provided a reduction of copper oxide located on the surface breaking open such copper oxide layer during a sintering step even in case of lower quality copper powders providing a higher amount of copper oxide. Although, it is explicitly pointed out that this should not limit the scope of the claims in any way it is assumed by the inventors that breaking open such oxide layer in a consistent and distributed way over the surface of the metal particles during the sintering process allows to more easily achieve a homogeneous and reliable connection between the metal particles enabling to provide highest quality products from binder jetting and metal injection molding. Suffering very little to even not at all from an impaired metallic particle quality with even fluctuating oxide layer thicknesses on the surface of said particles.

Furthermore, it was noted with regard to the Fe based alloy metal particles that utilizing a Fe based alloy metal particle providing a delta ferrite structure being thermodynamically stable in the temperature ranges of 80% to 100% of solidus temperature is especially beneficial. The determination of such structure can be determined utilizing preferably Thermocalc (thermodynamic) simulation. It was noted that corresponding Fe based alloy metal particles provide even improved properties. It is assumed that such particles provide these further improved properties based on an increased volumetric shrinkage and reduced carbon solubility leading to a more efficient use of the carbon nanoparticles and/or graphene and a significantly increased densification of the manufactured product.

According to further embodiments it is preferred that the core is a copper based metallic particle. It was noted that corresponding metallic powder materials provide additional beneficial effects not only adding to the benefits already described above, but synergistically improve, for example, a manufacturing of a component manufactured from it. While this should also not limit the application in any way it is assumed by the inventors that this is related to the low solubility of carbon on copper resulting in a maximized effect of the low amount of carbon nanoparticles and/or graphene located on the surface. Ensuring that even under very harsh conditions no carbon is preemptively or early consumed based on said solubility reducing the inventive effect. Although, said low solubility does not appear to completely explain the beneficial results obtained with binder jetting and metal injection molding indicating further effects contributing to the benefits observed in this context.

According to a further aspect the present invention refers to a method of manufacturing a component using binder jetting or metal injection molding, wherein the binder jetting step or metal injection molding step uses the inventive metal powder particles. As described above it was noted that the corresponding manufacturing methods provide especially good results when utilizing the inventive metallic powder material. For example, the density of corresponding green bodies is especially high even under very simple processing conditions and little effort. Furthermore, the products manufactured accordingly show a lower amount of oxides after sintering. Neither distributed nor as enclosures spread throughout the products. It is assumed that these and further microscopic differences lead to further improved properties like increased stability and the like. Supposedly originating from the lack of weaking points possibly originating from such enclosed oxide spots possibly originating from oxides located on the surface of the metal powder particles impeding the metallic diffusion between core particles during the sintering/consolidation process or developing during sintering steps or the like.

Binder jetting is known to the skilled person as “an additive manufacturing process in which a liquid bonding agent is selectively deposited to join powder materials”. The liquid bonding agent, also called the binder, is jetted through several nozzles present on the printhead. The most common spreading mechanism for creating layers in BJ is using a counter-rotating roller as it offers improvements for powder flowability and spreadability. Binder is deposited on the newly spread powder layer as per the required cross-section. The deposited binder is then dried using a heater and the whole cycle is repeated for a new layer. Utilizing such method a green body is manufactured providing the desired shape.

Utilizing a curing process the binder is hardened increasing the green strength of the product by polymerizing the binder. For most binders, polymerization is initiated using heat. Curing temperature, time, and atmosphere, are selected based on the binder chemistry.

During a debinding step after such curing and removal of loose powder, the parts are exposed to further heating in a furnace to decompose the polymerized binder.

To further improve the properties of the manufactured component is subjected to a subsequent sintering process. Sintering is a heat treatment whereby a powder, either loose or prior compacted, is transformed in a coherent body due to the formation of a chemical bonding between the particles. The exposition of the material to a high temperature, lower than the melting point of the powder (Solid State Sintering), allows for the formation of the so called sintering neck, a volume of material that chemically bonds the particles. Sintering may be activated by the presence of a liquid phase.

According to a further aspect the present invention refers to a green body manufactured by binder jetting or metal injection molding according to the inventive method. As explained above it was noted that corresponding green bodies manufactured accordingly provide especially beneficial properties.

To simplify understanding of the present invention it is referred to the detailed description hereafter. Herein, the figures are to be understood being not limiting the scope of the present invention but disclosing preferred embodiments explaining the invention further.

According to one aspect, the present invention refers to a metallic powder material as specified above.

The term “copper based metallic particle” as used herein refers to a metallic particle consisting of at least at least 50 wt.-% Cu, more preferred at least 60 wt.-% Cu, even more preferred at least 90 wt.-% Cu, based on the total weight of the other alloying elements in copper based metallic particle. Typically, it is preferred that the metallic particle consists of at least 99 wt.-%, ever more preferred at least 99.5 wt.-%, copper, based on the total weight of the copper based metallic particle.

The preparation of the coating on the surface of the cores of the metallic powder material can be realized, for example, very easily by mixing the cores and the carbon nanoparticles and/or graphene, for example, utilizing a turbula mixer as an example of a rotative drum mixer that can be utilized in this context. Alternatively, for example, corresponding carbon nanoparticles and/or graphene can be coated onto the surface of the cores by electrostatic assembly. It has to be understood that such coating neither requires to fill the whole surface of the cores nor do the carbon nanoparticles and/or graphene require a chemical bond of said carbon nanoparticles and/or graphene to the core.

The average amount of carbon nanoparticles can be determined utilizing typical methods available to the skilled person. For example, it can be determined by thermodynamic simulations and Ellingham diagrams, given the size of carbon nanoparticles (specific surface area), the weight fraction of alloying elements that show high affinity for oxygen, sintering atmosphere, and temperature. Alternatively burning the carbon nanoparticles mixture with core particles in laboratory scale and determining the amount of carbon monoxide and/or carbon dioxide set free when the said carbothermal reduction takes place.

The term “Dx” as used herein like D₁₀, D₅₀ or D₉₀ refers to the particle size at which X wt.-% of the particles provide at most this particle size determined utilizing volume average particle size distribution. For example, a D₅₀ of 30 μm characterizes that 50 wt.-% of the particles provide a particle size of 30 μm or less determined utilizing volume average particle size distribution. The determination of the D₅₀ is, for example, realized using laser granulometry utilizing a particle size measurement device of the company Quantachrome (device: Cilas 1064). The measurement is performed according to the manufacturer specifications. For this purpose, 1.5 g of the powder material is dispersed in 100 ml ethanol, treated for 300 seconds in an ultrasonic bath (device: Sonorex IK 52, company Bandelin) and then placed in the sample preparation cell of the measuring device using a Pasteur pipette and measured several times. The resulting average values are formed from the individual measurement results. The evaluation of the scattered light signals is carried out according to the Fraunhofer method.

The term “nanoparticles” as used herein refers to the typical material as known to the skilled person. Preferably, it refers to particles providing a size (i.e., equivalent diameter) of at most 500 nm, more preferred at most 200 nm, even more preferred at most 100 nm. The size of corresponding nanoparticles can be determined using conventional means available to the skilled person like preferably Transmission electron microscopy (TEM). Other methods known to the skilled person can also be employed as demanded like High-resolution scanning electron microscopy (FE-SEM).

According to further embodiments it is preferred that the graphene, wherein the graphene consists of nano platelets providing a thickness of less than 10nm and a diameter of less than 25 μm, more preferably less than 1.5 μm. It was noted that corresponding graphene material is not only very simple, widely commercialized and reliably applicable for such purpose, while providing a reliable effect.

According to further embodiments it is preferred that the average amount of carbon nanoparticles is selected from the range from 0.011 wt.-% to 0.04 wt.-%, more preferred from the range from 0.011 wt.-% to 0.02 wt.-%, even more preferred from the range from 0.015 wt.-% to 0.020 wt.-%, based on the total weight of the metal powder particles.

For typical application cases it was noted to be especially useful to adapt the amount of carbon nanoparticles in relation to the size of the carbon nanoparticles. According to further embodiments it is preferred that at least 95 wt.-%, more preferred at least 99 wt.-%, even more preferred 100 wt.-% of the carbon nanoparticles, based on the total weight of the carbon nanoparticles, provide a size of at most 100 nm, and wherein the average amount of carbon nanoparticles is selected from the range from 0.01 wt.-% to 0.02 wt.-%, even more preferred from 0.012 wt.-% to 0.018 wt.-%, based on the total weight of the metal powder particles. It was noted that the inventive effect and especially pronounced effects referring to the reduction of oxides located on the surface of the metal particles was reliably provided easily compensating fluctuating qualities of the core particles significantly simplifying the overall method.

According to further embodiments it is preferred that the total weight of the core, carbon nanoparticles and graphene of the metal powder particles amount to at least 99 wt.-%, preferably at least 99.5 wt.-%, even more preferred at least 99.9 wt.-%, of the metallic powder material, based on the total weight of the metallic powder material. It was, for example, noted that such powder has a surprisingly good processability allowing to include a tailored material for binder jetting or metal injection molding as desired. Allowing to minimize any additional material significantly increasing the effect of the coating. Said increased effect of the inventive coating of the metallic powder material renders the effort and also additional costs required for such metallic powder material and the nanoparticles and graphene utilized in this context.

According to further embodiments it is preferred that the metal powder particles provide a D₉₀ selected from the range from 16 μm to 53 μm, more preferred from 16 μm to 45 μm, even more preferred from 16 μm to 32 μm. even more preferred from 16 μm to 25 μm It was noted that corresponding metal powder particles provide an emphasized effect for typical applications rendering their utilization beneficial.

According to further embodiments it is preferred that the metal powder particles are essentially spherical. Corresponding metal powder particles provide a very good behavior under typical conditions utilized for binder jetting and metal injection molding. The term “essentially spherical” as used herein refers to metallic powder particles wherein the core of at least 50 wt.-%, preferably at least 60 wt.-%, more preferred at least 80 wt.-%, even more preferred at least 90 wt. %, of said cores, based on the weight-% of said cores, of said metal powder provide an average ratio of the shortest Feret diameter to the longest Feret diameter being selected from the range of 0.80 to 1.0, preferably selected from the range from 0.85 to 1.0, even more preferred selected from the range from 0.875 to 1.0. The average ratio is typically preferred to be based on the arithmetic mean of the corresponding ratios of Feret diameters of least 100 particles being measured. In case the shapes of the particles deviate significantly the skilled person is well aware to measure the ratio of a higher number of particles like at least 1000 particles to achieve a statistical reliable result.

According to a further aspect the present invention refers to a method of manufacturing a component using binder jetting or metal injection molding, wherein the binder jetting step or metal injection molding step uses the inventive metallic powder material. Herein, the method contains the step of mixing a binder material to the metallic powder material during the binder jetting step or before the metal injection molding step. Surprisingly, it was noted that carbon introduced by a corresponding binder does not seem to contribute to the inventive effect.

Although, it is not to be interpreted as any limitation of the claimed scope it is assumed that carbon provided by the binder is, for example, burning away during a sintering step to fast. While the localized carbon of the carbon nanoparticles or graphene is localized and at least partially breaks apart a surface oxide layer rendering a more homogeneous and reliable bonding of the particles possible.

According to further embodiments it is preferred that the method contains the step of sintering a green body manufactured in the binder jetting step or a brown body manufactured in the metal injection molding, wherein before the sintering a curing and debinding process is carried out. While it is common to label the binder jetting product green body also after debinding, during a metal injection molding step the product of a metal injection molding manufacturing procedure is called brown body while being also called green body before the debinding step.

According to further embodiments it is preferred that the method contains the step of sintering a green body manufactured in the binder jetting step or a brown body manufactured in the metal injection molding step, wherein preferably the temperature during the sintering is selected from the range from 950 to 1080 °C for copper based metallic particle, 1200-1300 °C for Ni based alloy metallic particles, and 1300-1400 °C for Fe based alloy metallic particles.

According to further embodiments it is preferred that the component is a heat exchanger or any heat transfer component in case of copper alloy or gas-turbine engines, combustor parts, burners, exhaust-end components, transition pieces, and high-temperature gas cooled reactors in case of Ni super alloy, or filters or strainers and structural parts, and tools in case of Fe based alloy. Corresponding components seem to benefit especially from the benefits obtained by the inventive metallic powder material.

According to further embodiments it is preferred that the component is a continuous flow engine component like vanes, blades, heat shields, burners or parts of such burners.

The term “continuous flow engine” as used herein refers to a device utilizing a continuous stream of a fluid like a gas or a liquid. Herein, such continuous flow engine typically provides a rotor located in the fluid and interacting with said fluid. Herein, such fluid can either be utilized to provide a rotational movement of the rotor being able to be transformed into, for example, electrical energy. Examples of such continuous flow engines are gas turbines and steam turbines. Alternatively, the rotor can actively be rotated allowing to, for example, compress the fluid. An example of such application is a compressor as utilized, for example, in oil refineries.

According to further aspects the present invention refers to a green body manufactured by binder jetting or a green body or brown body manufactured by metal injection molding according to the inventive method.

The present invention was only described in further detail for explanatory purposes. However, the invention is not to be understood being limited to these embodiments as they represent embodiments providing benefits to solve specific problems or fulfilling specific needs. The scope of the protection should be understood to be only limited by the claims attached.

1. A metallic powder material consisting of separate metal powder particles,
wherein the metal powder particles each contain a core and a coating containing carbon nanoparticles and/or graphene,
wherein the core is a copper based metallic particle, a Ni based superalloy metal particle and/or a Fe based alloy metal particle,
wherein the Ni based superalloy metal particle contains a total amount of Al and Ti being less than 1 wt. % and a total amount of V, Zr, Nb, Ta and Y of less than 0.5 wt. %, based on the total weight of the Ni based superalloy, metallic particle,
wherein the Fe based alloy metal particle contains a total amount of Al and Ti being less than 1 wt. %, a total amount of V, Zr, Nb, Hf and Y being less than 0.5 wt. %,
wherein the metal powder particles provide a D₉₀ of at most 53 μm,
wherein the average amount of carbon nanoparticles is selected from the range from 0.01 wt.-% to 0.05 wt.-%, based on the total weight of the metal powder particles.

2. The metallic powder material according to claim 1,
wherein the core is a copper based metallic particle.

3. The metallic powder material according to claim 1,
wherein the graphene consists of nano platelets providing a thickness of less than 10 nm and a diameter of less than 25 μm.

4. The metallic powder material according to claim 1,
wherein the average amount of carbon nanoparticles is selected from the range from 0.011 wt.-% to 0.04 wt.-%, based on the total weight of the metal powder particles.

5. The metallic powder material according to claim 1,
wherein the total weight of the core, carbon nanoparticles and graphene of the metal powder particles amount to at least 99 wt.-% of the metallic powder material, based on the total weight of the metallic powder material.

6. The metallic powder material according to claim 1,
wherein the metal powder particles provide a D₉₀ selected from the range from 16 μm to 53 μm.

7. The metallic powder material according to claim 1,
wherein at least 95 wt.-% of the carbon nanoparticles, based on the total weight of the carbon nanoparticles, provide a size of at most 100 nm, and
wherein the average amount of carbon nanoparticles selected from the range from 0.01 wt.-% to 0.02 wt.-%, based on the total weight of the metal powder particles

8. The metallic powder material according to claim 1,
wherein the metal powder particles are essentially spherical.

9. A method of manufacturing a component comprising:
binder jetting or metal injection molding,
wherein the binder jetting or the metal injection molding uses the metallic powder material according to claim 1.

10. The method according to claim 9, comprising:
mixing a binder material to the metallic powder material during the binder jetting or before the metal injection molding.

11. The method according to claim 9, comprising:
sintering a green body manufactured by binder jetting or a brown body manufactured by metal injection molding,
wherein before the sintering, a curing and debinding process is carried out.

12. The method according to claim 9, comprising:
sintering a green body manufactured by binder jetting or metal injection molding.

13. The method according to claim 9,
wherein the component is a heat exchanger or any heat transfer component in case of copper alloy or gas-turbine engines, combustor parts, burners, exhaust-end components, transition pieces, and high-temperature gas cooled reactors in case of Ni super alloy, or filters or strainers and structural parts, and tools in case of Fe based alloy.

14. The method according to claim 9, wherein the component is a continuous flow engine component.

15. A green body manufactured by binder jetting, green body manufactured by metal injection molding or brown body manufactured by metal injection molding according to the method of claim 9.

16. The metallic powder material according to claim 1,
providing a delta ferrite structure being thermodynamically stable in the temperature ranges of 80% to 100% of solidus temperature.

17. The method according to claim 12,
wherein the temperature during the sintering is selected from the range from 950 to 1080 °C for copper based metallic particle, 1200-1300 C for Ni based alloy metallic particles, and 1300-1400 °C for Fe based alloy metallic particles.
